(19) United States
(12) Patent Application Publication
(10) Pub. No.: US 2020/0370372 A1
(43) Pub. Date: Nov. 26, 2020

(54) RESCUE LADDER ATTACHMENT

(71) Applicant: Ross Hoffmann, Prospect, KY (US)

(72) Inventor: Ross Hoffmann, Prospect, KY (US)

(21) Appl. No.: 16/993,027

(22) Filed: Aug. 13, 2020

Related U.S. Application Data
(63) Continuation-in-part of application No. 16/662,926, filed on Oct. 24, 2019.
Application No. 16/662,926 is a continuation-in-part of application No. 16/275,196, filed on Feb. 13, 2019.

(51) Int. Cl. E06C 7/02; E06C 1/38; E06C 7/06

(52) U.S. Cl. CPC E06C 7/02; E06C 7/06; E06C 1/38

(57) ABSTRACT

A safety rescue attachment for a ladder includes a foldable safety extension having a ladder engagement clamp on a terminal end thereof.

### BACKGROUND OF THE INVENTION

### Field of the Invention

The present invention relates generally to an apparatus for converting a conventional ladder into an emergency rescue ladder. The apparatus described is a removable ladder attachment that secures quickly to a conventional ladder and provides a hinged extension that may be positioned in a break or hole in a semi-frozen body of water to aid in rescue operations.

### Description of the Related Art

In rescue events where a person or animal has fallen through the ice surface of a semi-frozen body of water it is often impossible for a rescuer to place much weight on the unstable ice surface, thus making it difficult to reach a person who has fallen through the ice. Obviously, time is of the essence in in these situations, since hypothermia and the attendant loss of motor and cognitive function set in quickly as body temperature plummets.

Various devices have been developed and used to assist in ice-breakthrough rescues, including various rope devices and ladders. The use of a rescue ladder offers some advantages, since the ladder provides a pair of opposed side rails that distribute weight across a width of the ice surface and can easily be slid towards the ice break from a distance. Once the ladder has been extended to the break area, the person being rescued need only hold on to a ladder rung and the rescuers can then pull the ladder back towards a more stable section of ice, or the shoreline.

The use of a conventional ladder in ice rescues does suffer from several disadvantages however. In some instances the person being rescued may not be capable of holding onto a ladder rung tightly enough to be pulled out of the water as the ladder is retracted by rescuers. Furthermore, in some instances it is desirable to be able to lower a portion of the ladder into the hole caused by the break in the ice, so that a victim can place his or her feet on a rung and thus be pulled out of the water to safety. However, with conventional ladders that simply lay flat on the ice surface this is impossible.

Accordingly, there is a need in the art for an apparatus to be used in conjunction with a ladder to assist in ice-breakthrough rescue operations that is quick to assemble, readily deployed, and capable of being lowered or placed at least partially in the water to enable a victim to grasp the rescue apparatus.

### SUMMARY OF THE INVENTION

The present disclosure is related to an apparatus for providing a ladder attachment that converts a conventional ladder to a rescue ladder. The system described herein provides a ladder attachment that is wider than the width of the ladder to which it is attached. The ladder attachment may include a pair of spaced apart side rails that are secured together by at least one rung.

In various embodiments, the system disclosed herein provides an attachment that includes at least one end having a removable rung or pin that slides through two opposed apertures in the side rails of the attachment. This removable rung acts as a hinge when the attachment is secured to a conventional ladder by aligning the opposed apertures with the end rung of a conventional ladder and then inserting the removable pin through the cylindrical rung. This feature of the system enables a rescuer or rescue team to rapidly deploy the ladder attachment, quickly securing it to a longer ladder for emergency use.

In some embodiments and aspects both ends of the attachment may include a removable pin. In these embodiments the attachment may be used to secure two ladders together as needed. In other aspects and embodiments one end of the attachment may include a step or foothold to assist a person being rescued whereby the step end of the attachment may be placed in the water.

In various implementations set forth, a removable ladder attachment for use with a ladder of predetermined size having at least one hollow rung is described. The removable ladder attachment may have a first and a second side rail having a plurality of rungs extending between the first and the second side rail, wherein the plurality of rungs separate the first and the second side rail by a first predetermined width. The removable latter may also have a first aperture formed in the first side rail and a second aperture formed in the second side rail substantially opposing the first aperture. The removable ladder may also include a removable rung insertable through the first aperture and the second aperture and extending between the first side rail and the second side rail wherein a first end of the removable rung is extends beyond the first rail and a second end of the removable run extends beyond the second rail. In some implementations, the first predetermined width of the removable ladder attachment is greater than a second predetermined width of the ladder of predetermined size having at least one hollow rung to which the removable ladder is to be pivotally attached. In further implementations, the removable rung is sized to extend through the at least one hollow rung of the ladder of predetermined size and through the first and the second aperture of the removable ladder and be releasably locked in place.

In some aspects and embodiments a universal apparatus for securing a pair of rescue ladders together is provided. In these embodiments a pair of end clamps operate to secure a pair of rods that engage hollow ladder rungs, thereby connecting the end rungs of two different ladders together. In some further embodiments the apparatus may include a pair of foldable legs that are secured on a single end by a clamp. By utilizing a simple, lightweight, and readily assembled apparatus for securing two ladders together, a rescue crew can rapidly connect and deploy a pair of ladders for use in an ice or water rescue emergency.

In some additional embodiments two pairs of opposed spring-loaded clamps may be provided to secure adjacent rungs of two ladders together, thereby providing for rapid attachment and disassembly.

The term “ladder” as used herein includes any type of ladder having a rung or rungs that are cylindrically and hollow so that the removable rung or pin of the attachment may be positioned there through.

It should be appreciated that all combinations of the foregoing concepts and additional concepts discussed in greater detail below (provided such concepts are not mutually inconsistent) are part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

Other features, objects and advantages of the present invention will become apparent from the detailed description of the drawing Figures taken in conjunction with the appended drawing Figures.

### BRIEF DESCRIPTION OF THE DRAWING FIGURES

In the drawings, like reference characters generally refer to the same parts throughout the different views. The drawings are not necessarily to scale. Emphasis is instead generally placed upon illustrating the principles of the disclosure, wherein;

FIG. 1 is a perspective view of a ladder attachment in accordance with one embodiment of the present invention;

FIG. 2 is a perspective view of a ladder attachment being secured to a standard ladder in accordance with one embodiment of the present invention;

FIG. 3 is a perspective view of a ladder attachment in accordance with one embodiment of the present invention;

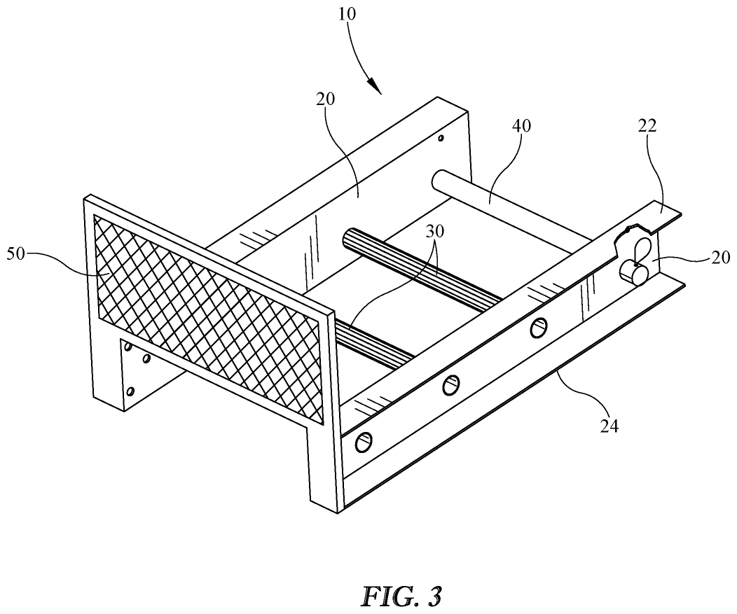

FIG. 4 is a partial perspective view of a ladder attachment and ladder being used in a rescue operation in accordance with one embodiment of the present invention;

FIG. 5 is a perspective view of a ladder attachment being used to join two standard ladders in accordance with one embodiment of the present invention; and

FIG. 6 is a perspective view of a ladder attachment in accordance with one embodiment of the present invention;

FIG. 7 is a perspective view of a ladder attachment in accordance with one embodiment of the present invention;

FIG. 8 is a perspective view of a ladder attachment in accordance with one embodiment of the present invention;

FIG. 9 is a perspective view of a ladder attachment secured to a ladder in accordance with one embodiment of the present invention; and

FIG. 10 is a perspective view of a ladder attachment in accordance with one embodiment of the present invention.

### DETAILED DESCRIPTION OF THE PREFERRED EMBODIMENT(S)

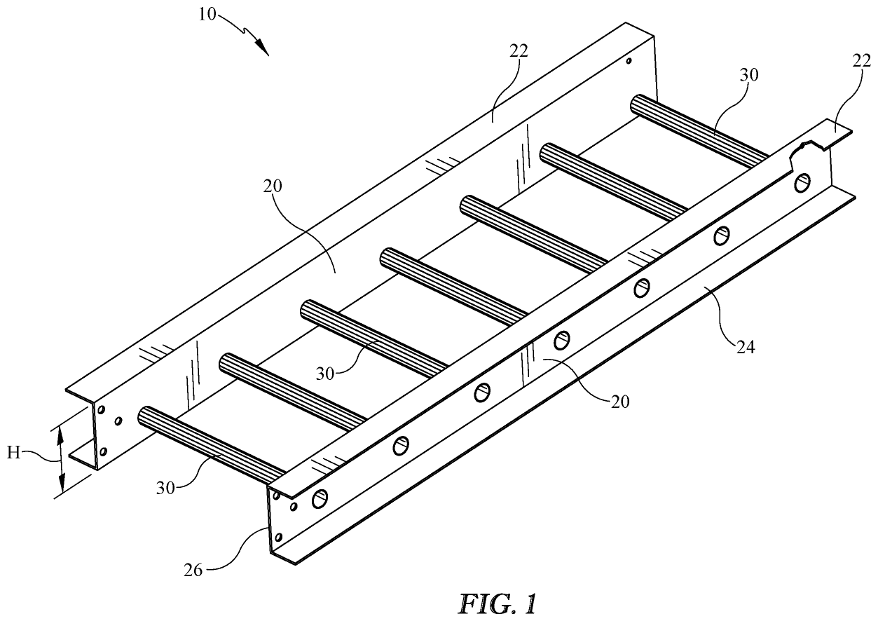

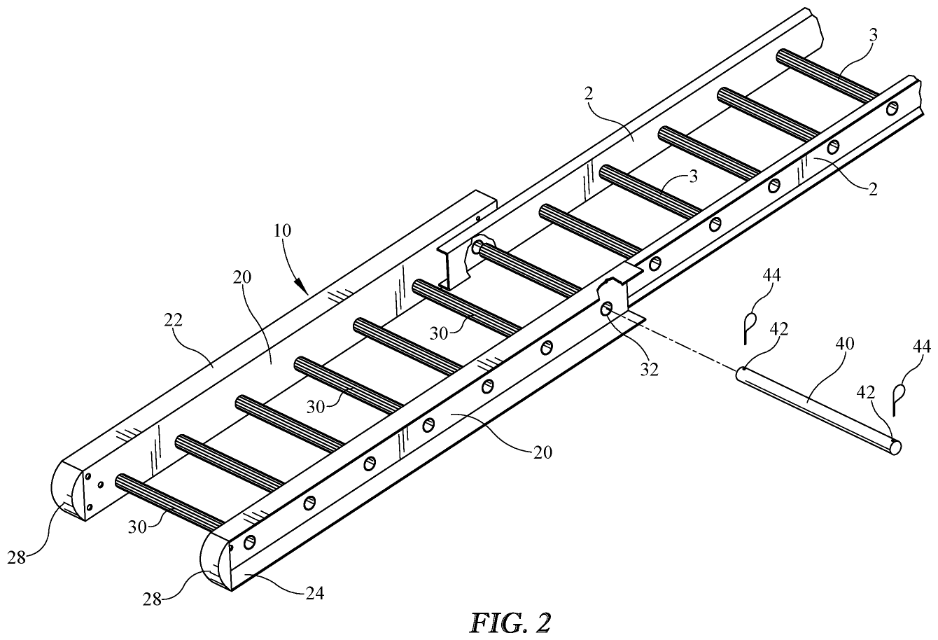

Referring now to drawing FIGS. 1 and 2, and in accordance with various embodiments of the invention, the system described herein overcomes the aforementioned difficulties in the prior art by providing a ladder attachment apparatus 10 for facilitating ice-breakthrough rescue. In various aspects of the invention, the attachment apparatus 10 is constructed to be used in conjunction with a conventional ladder 1 of predetermined size. Ladder 1 may include a pair of spaced side rails 2 separated by a plurality of rungs 3. In various aspects ladder 1 rungs 3 are typically shaped as hollow cylinders, whereby a pin or rod may be inserted into and through rungs 3, as will be discussed further herein below.

In some embodiments ladder 1 is constructed to have a conventional spacing between rails 2, for example 12 or 16 inches, although one of ordinary skill will understand that a wide variety of ladder 1 rail 2 spacings are capable of being employed in conjunction with attachment apparatus 10 without departing from the scope of the invention. Furthermore a ladder or ladders 1 used in conjunction with apparatus 10 may have any length and still be capable of being utilized with apparatus 10. It should be noted that commercial emergency and residential use ladders are typically manufactured in compliance with safety and sizing standards set by the Occupational Safety and Health Administration (OSHA) as well as the American Ladder Institute (ALI). The invention disclosed herein is, in some embodiments, intended to be operable with a many of the ladders 1 manufactured according to these standards, but it should be understood that the invention is not limited to use with ladders 1 manufactured in such a fashion

In various embodiments attachment apparatus 10 is constructed of a pair of spaced, generally parallel side rails 20 secured together by at least one rung 30. Side rails 20 may be constructed to have top 22 and bottom 24 flanges that extend outwardly away from rails 20, thereby providing a surface along which attachment 10 may slide during use. Top and bottom flanges 22, 24 may be produced in a variety of widths. For example, in some embodiments a three inch wide top and bottom flange 22, 24 may be employed to facilitate sliding across ice 5 and further to increase the surface area over which weight is distributed when a person being rescued is being pulled to safety, thereby reducing the possibility of additional breakthroughs.

In some exemplary embodiments top flange 22 and bottom flange 24 may terminate at either end 26 of attachment 10 in a curved or chamfered edge 28, thereby enabling attachment 10 to slide or glide along an ice 5 surface without digging in or causing undue resistance. Furthermore, spaced side rails 20 are spaced apart to be slightly wider than the ladder 1 to which attachment 10 is being secured, so that side rails 20 can be positioned outside the rails of a conventional ladder 1, as will be discussed further herein below.

In some embodiments depicted in FIGS. 1, 2 and 5, ladder attachment 10 includes a removable rung or pin 40, or alternatively a pair of removable pins 40 at either end, one at each end of attachment 10. Removable pin 40 may include an aperture 42 at each end thereof, to accept a cotter pin 44 or similar fastener. Side rails 20 of attachment 10 may include at least one pair of opposed apertures 32 through which removable pin 40 may be inserted. When ladder attachment 10 is not in use, removable pin 40 is simply inserted through apertures 32 and secured in place with a removable pin 44 or similar fastener. Removably fastening rung or pin 40 into the apertures of the ladder attachment 10 may be accomplished through other fastening structures instead of a cotter pin 44. For example, spring loaded depression buttons may be formed in the rung 40 in place of the apertures 42 which would lock the rung/pin 40 in position at either end. Other types of fasteners may be utilized to allow the rung 40 to be removed from an attached configuration affixing the ladder attachment 10 to the ladder 1 and within rung 3.

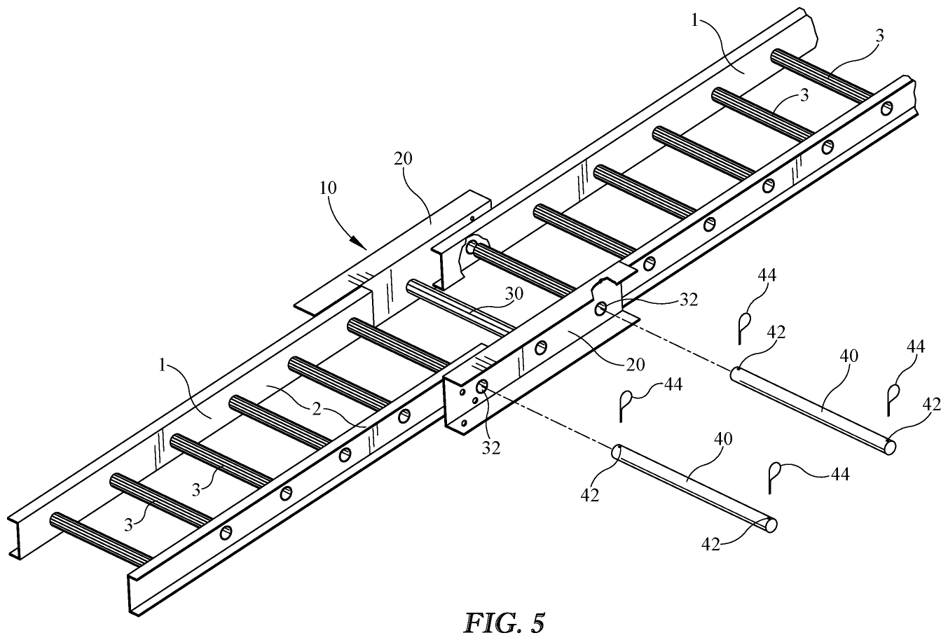

As best seen in FIG. 5 the removable attachment 10 may be removably secured to ladder 1 by removing pins 44 from the rung/pin 40 of the attachment 10, positioning side rails 20 of attachment outside an end rung 3 of ladder 1, aligning apertures 32 with the end rung 3 and then sliding removable pin 40 through the hollow end rung 3. Once through, removable pin 40 can be removably secured by inserting a cotter pin 44 through the apertures 42 and either end thereof. In some embodiments removable pin 40 may be replaced with a collapsible cylindrical rung 40 that is capable of sliding through apertures 32.

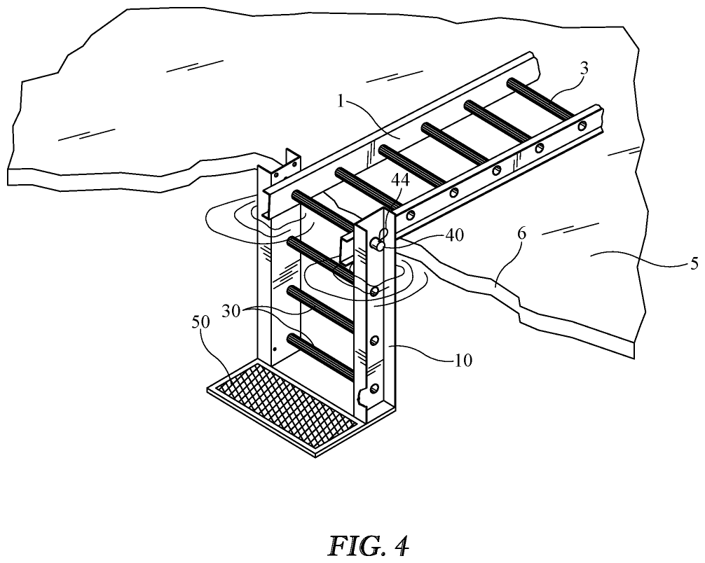

Once secured as described herein above and as depicted in FIG. 4, ladder attachment 10 is capable of being positioned in a break or hole 6 in an ice surface 5 by simply sliding ladder 1 toward the hole 6, and then letting attachment 10 slide into the hole 6. Since attachment 10 is secured to ladder 1 by a pin 40 through the hollow ladder rung 3, attachment 10 is free to pivot around the central axis of pin 40, thereby allowing attachment 10 to slide down into hole 6 to be grasped or stood on by a person being rescued. In some embodiments, where attachment 10 is constructed to be relatively short from end to end, it may be easily lowered into even a small hole 6 or break in the ice 5. In a yet further embodiment in of the invention, one end of attachment 10 may be provided with a step 50 that extends outwardly to facilitate standing by a person being rescued. Step 50 may be constructed as a grate or other non-slip surface to enhance traction. In these embodiments the step 50 is positioned away from the ladder 1 to which attachment 10 is being secured so that it enters the hole 6 first when attachment is properly positioned.

In some aspects and embodiments of the invention, and as best depicted in FIG. 5, ladder attachment 10 may include two removable rungs 40, one at each end thereof, positioned in two pairs of opposed apertures 32 respectively. In these embodiments, attachment 10 may be used to quickly secure two ladders 1 together where a longer length is need to reach someone in a rescue situation. Each rung 40 is inserted through an aperture of end rung 3 of one of the ladders 1 and then secured in place, thereby providing a rescuer a very quick and simple system for securing two ladders together. Furthermore, in some embodiments, attachment 10 may include a removable rung 40 at each end and just a single rung 30, thereby providing a compact and easy to store ladder attachment 10 for ice rescues. This embodiment of the invention is advantageous since the space needed to store the attachment 10 is minimal and can be accommodated by most fire trucks and emergency response vehicles.

It should be noted that ladder attachment apparatus 10 may be constructed of any conventional material that is commonly used for a conventional ladder, such as fiberglass, aluminum, steel, or even wood without departing from the scope of the invention. Furthermore, attachment 10 may be constructed in a wide variety of sizes. Spaced rails 20 need only be slightly wider than the ladder 1 to which the attachment is being secured. Additionally, attachment 10 may include a plurality of rungs 30, or just one rung 30 depending on the space and storage needs of the user.

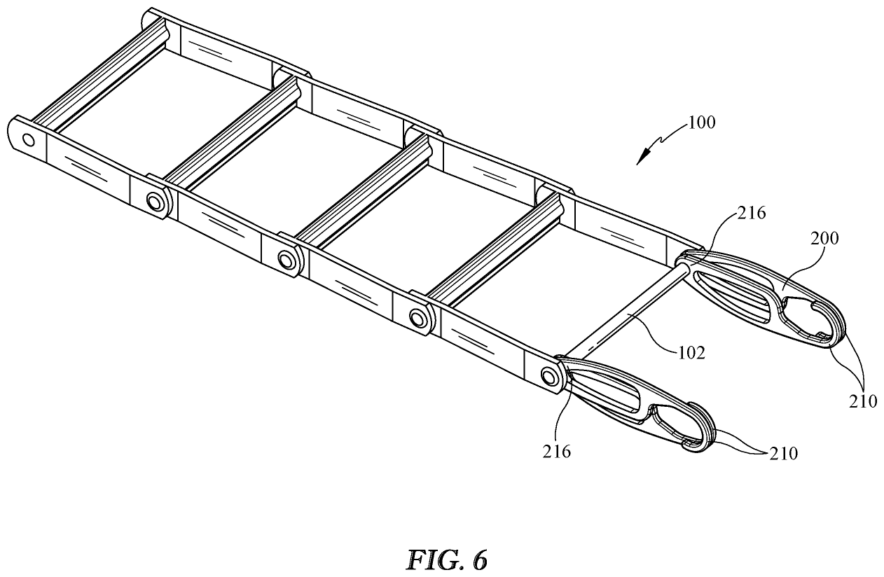

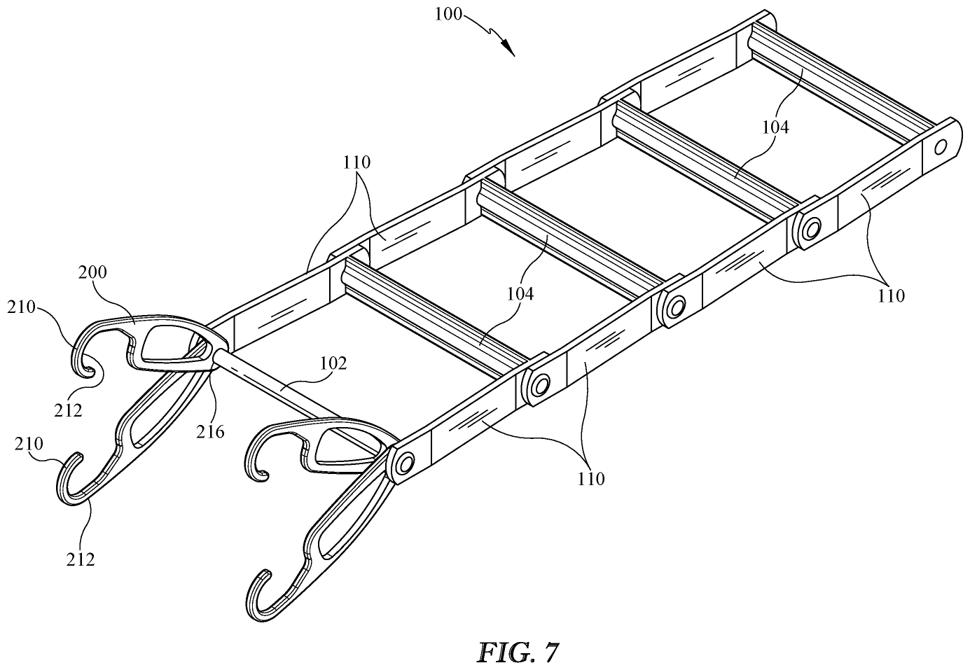

Referring now to FIGS. 6-8, and in accordance with some embodiments and aspects, an apparatus 100 for securing a pair of ladders 1 together includes a pair of folding end clamps 200 each having a pair of hinged hooks 210 having an open end 212 and a terminal end 216 that is rotatably secured to a terminal rung 102 of apparatus 100. In some aspects and embodiments end clamps 200 are spring-loaded so that each pair of hooks 210 “snaps” back in place to overlap each other and thus engage a ladder rung 3.

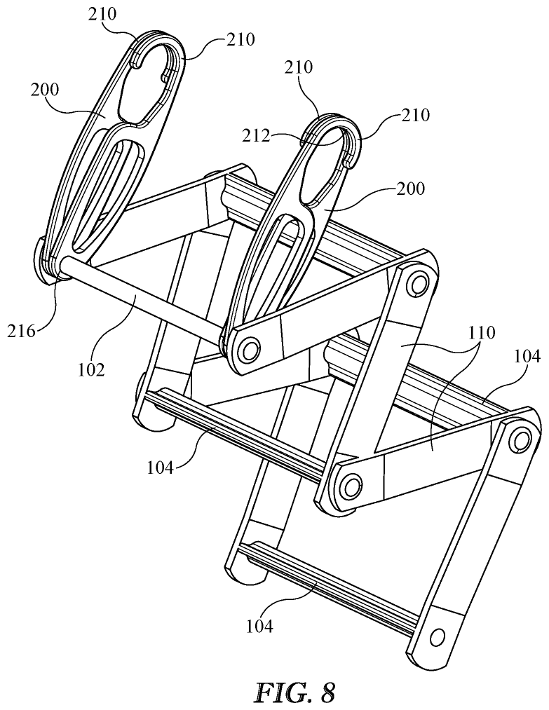

In the exemplary embodiments shown in FIGS. 6-8 apparatus 100 may further include a plurality of graduated, interconnected, nesting rungs 104 that are secured to each other by a plurality of hinged legs 110. Each nesting rung 104 is sized such that rungs 104 and legs 110 may be folded or collapsed on each other for storage purposes, as best shown in FIG. 8. In some aspects legs 110 are sized so that each successive leg 110 pair is shorter than its successor and each concomitant rung 104 is sized so the each successive rung 104 is slightly shorter than its successor, so that apparatus 100 may fold compactly.

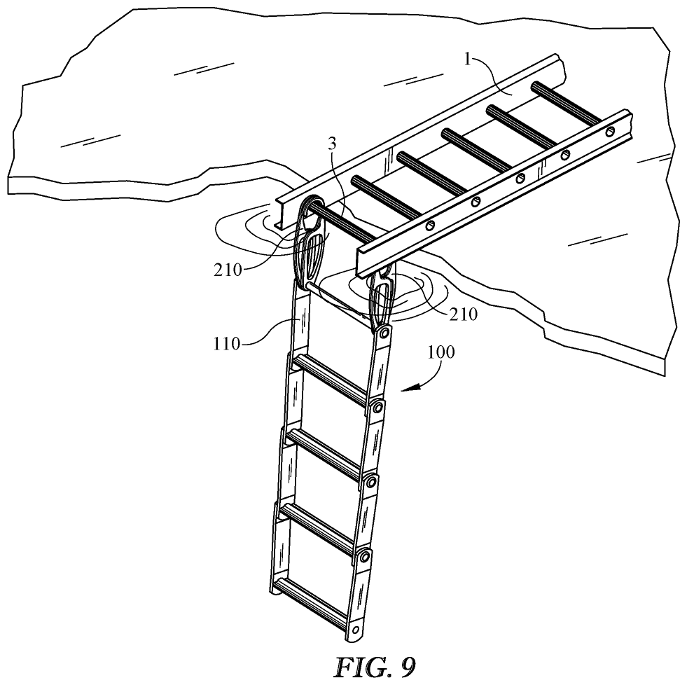

Thus apparatus 100 may readily be folded or collapsed and stowed in a compact location. As best seen in FIG. 9, when needed, apparatus 100 may quickly be unfolded and deployed by simply opening clamps 200, thereby separating hinged hooks 210 and then placing the open ends 212 thereof over a ladder rung 3 as depicted in FIG. 9. Hinged hooks are then placed back together to overlap each other and thus engage rung 3. Apparatus 100 is thus readily deployed for use as a rescue ladder attachment with little time and effort, and also takes of very little space in the trunk of a vehicle or a storage compartment on a fire truck or ambulance.

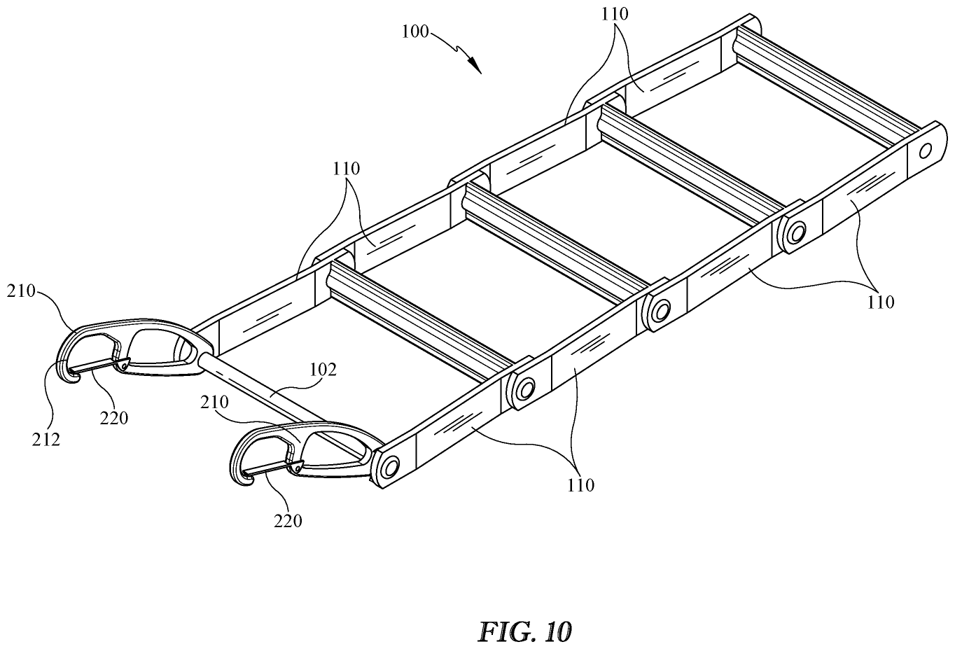

Referring to FIG. 10, and in accordance with some embodiments, an opposed pair of clamps 200 each having a single hinged hook 210 are provided at a terminal rung 102 of apparatus 100. Hooks 210 have an open end 212 that is closed by a spring-loaded clip 220, similar to that of a carabineer, to allow each hook to “snap” in place over a ladder rung 3. In each of these embodiments depicted in FIGS. 6-10 the apparatus 100 described herein is quickly and readily deployed from a stowed position and secured to a ladder 1 to effect an emergency rescue.

While the present invention has been shown and described herein in what are considered to be the preferred embodiments thereof, illustrating the results and advantages over the prior art obtained through the present invention, the invention is not limited to those specific embodiments. Thus, the forms of the invention shown and described herein are to be taken as illustrative only and other embodiments may be selected without departing from the scope of the present invention, as set forth in the claims appended hereto.

I claim:

1. A universal apparatus for extending a ladder having at least one rung comprising:
a safety extension having a plurality of spaced rungs; and
a ladder connector having a first end secured to a one of said safety extension rungs and a second end having a clamp thereon for securing to a rung of said ladder.

2. The apparatus of claim 1 wherein said safety extension comprises:
a plurality of rungs, each of said rungs secured to pair of legs that are capable of rotation around said rungs.

3. The apparatus of claim 2 wherein said plurality of rungs have descending lengths and each of said pairs of legs has descending lengths to provide a nesting, foldable safety extension.

4. The apparatus of claim 1 wherein said ladder connector comprises:
a spring loaded folding clamp having a pair of spaced clamp ends for engaging a ladder rung.

5. The apparatus of claim 4 wherein said clamp ends are shaped to lock together when engaged by said ladder rung.

6. The apparatus of claim 1 wherein said ladder connector comprises:
an opposed pair of spring loaded folding clamps, each clamp having a pair of overlapping hook ends for engaging a ladder rung.

7. The apparatus of claim 1 wherein said ladder connector is rotatably secured to a terminal rung of said safety extension.

8. A universal apparatus for providing a safety extension for a ladder having at least one rung comprising:
a safety extension having a plurality of foldable connected rungs; and
a ladder connector having a first end secured to a terminal end of said safety extension and a second end having a pair of spaced clamps thereon for rotatably securing said extension to a rung of said ladder, whereby said safety extension rotates with respect to said ladder rung.

9. The apparatus of claim 8 wherein said safety extension comprises:
a plurality of rungs each secured to pair of opposed legs that are capable of rotation around said rungs.

10. The apparatus of claim 9 wherein said each successive rung of said plurality of rungs has a descending length and wherein each of said pair of legs has a descending length to provide a nesting, foldable safety extension.

11. The apparatus of claim 8 wherein said ladder connector comprises:
a spring loaded folding clamp having a pair of spaced clamp ends for engaging a ladder rung.

12. The apparatus of claim 11 wherein said clamp ends are shaped to lock together when engaged by said ladder rung.

13. The apparatus of claim 8 wherein said ladder connector comprises:
an opposed pair of spring loaded folding clamps, each clamp having a pair of overlapping hook ends for engaging a ladder rung.

14. The apparatus of claim 8 wherein said ladder connector is rotatably secured to a terminal rung of said safety extension.
